(19) United States
(12) Patent Application Publication
(10) Pub. No.: US 2008/0297635 A1
(43) Pub. Date: Dec. 4, 2008

(54) IMAGING APPARATUS

(75) Inventor: Jun Aoki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/128,074

(22) Filed: May 28, 2008

(30) Foreign Application Priority Data
May 29, 2007 (JP) 2007-141234

(51) Int. Cl. H04N 5/335

(52) U.S. Cl. 348/294; 348/E05.091

(57) ABSTRACT

An imaging apparatus for converting an object image formed by a taking optical system into an image signal, the imaging apparatus including: a solid-state imaging device for converting the object image into the image signal, attached to a case body of the imaging apparatus such that its light receiving plane is movable on a plane crossing an optical axis of the taking optical system; a first thermal conduction member attached to the solid-state imaging device; and a second thermal conduction member connected at one end to the first thermal conduction member and at the other end to a thermal radiation member having a thermal capacity greater than the first thermal conduction member.

This application claims benefit of Japanese Patent Application No. 2007-141234 filed in Japan on May 29, 2007, the contents of which are incorporated by this reference.

### BACKGROUND OF THE INVENTION

The present invention relates to imaging apparatus, and more particularly relates to the imaging apparatus with a solid-state imaging device having a means for thermal radiation.

Solid-state imaging devices using a semiconductor typically represented by CCD image sensor or CMOS image sensor are used as an imaging device in those imaging apparatus typically represented by digital camera. The dark current in these solid-state imaging devices using the semiconductor increases with a rise of temperature. Such an increase in dark current causes a deterioration of image quality of image to be taken. The rise of temperature also makes it difficult to secure a stability of electrical operation of the solid-state imaging device. As means against this, Japanese Patent Application Laid-Open 2006-191465 for example discloses a method for cooling a solid-state imaging device by bringing Peltier device into close contact to the solid-state imaging device.

On the other hand, when image is taken by holding a digital camera with hand, a hand shake might occur so as to cause a blur on the taken image. To prevent this, a method for moving the position of the solid-state imaging device so as to cancel the hand shake is disclosed for example in Japanese Patent Application Laid-Open hei-6-46314.

### SUMMARY OF THE INVENTION

In accordance with a first aspect of the invention, there is provided an imaging apparatus for converting an object image formed by a taking optical system into an image signal, the imaging apparatus including: a solid-state imaging device for converting the object image into the image signal, attached to a case body of the imaging apparatus such that its light receiving plane is movable on a plane crossing an optical axis of the taking optical system; a first thermal conduction member attached to the solid-state imaging device; and a second thermal conduction member connected at one end to the first thermal conduction member and at the other end to a thermal radiation member having a thermal capacity greater than the first thermal conduction member.

In a second aspect of the invention, the second thermal conduction member in the imaging apparatus according to the first aspect is formed of a member having flexibility.

In a third aspect of the invention, the second thermal conduction member in the imaging apparatus according to the first aspect is formed of a mesh-like metal.

In a fourth aspect of the invention, the first thermal conduction member in the imaging apparatus according to the first aspect is attached to only a portion of the solid-state imaging device where a heat output is large.

### BRIEF DESCRIPTION OF THE DRAWINGS

FIG. 1 shows outlines of a first embodiment of the imaging apparatus according to the invention.

FIG. 2 typically shows a translating direction, and construction of the portions of a drive mechanism and thermal radiation means of the solid-state imaging device in the first embodiment shown in FIG. 1.

FIG. 3 shows a section of FIG. 2.

FIG. 4 is a back side view showing the portion of a thermal radiation means of the solid-state imaging apparatus in a second embodiment.

### DESCRIPTION OF THE PREFERRED EMBODIMENTS

Some embodiments of the imaging apparatus according to the invention will be described below with reference to the drawings.

### Embodiment 1

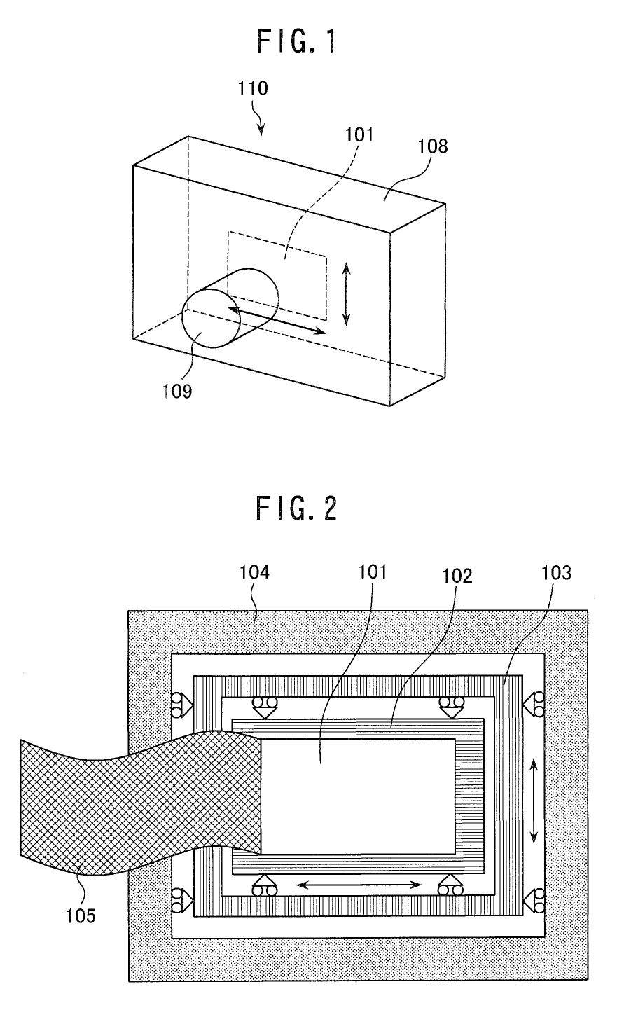

A first embodiment of the solid-state imaging apparatus according to the invention will now be described by way of the drawings. FIG. 1 shows outlines of an imaging apparatus 110. The imaging apparatus 110 takes image by forming an image of object (not shown) as object image on the light receiving plane of a solid-state imaging device 101 through a taking lens 109, and converts the object image into image signals.

The solid-state imaging device 101 is held so as to be translatable in the directions of arrows in the figure in relation to a case body 108 of the imaging apparatus. When the imaging apparatus at the time of image taking is shaken in the translating directions, the solid-state imaging device 101 is driven in position to cancel the shake so that the image to be taken is unaffected from the shake.

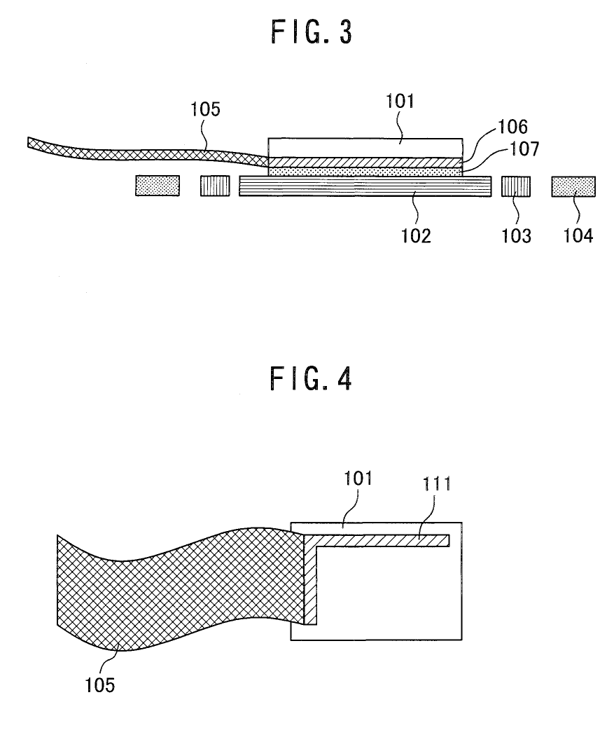

FIG. 2 typically shows the mechanism for driving the solid-state imaging device 101 in the translating directions. Further FIG. 3 shows a section of FIG. 2. Referring to FIGS. 2 and 3, what is denoted by 104 is a drive stage holding frame for holding the drive mechanism, which is fixed in relation to the imaging apparatus case body 108.

A y-direction drive stage 103 is held so as to be drivable only in the y-direction with respect to the drive stage holding frame 104. An x-direction drive stage 102 is held so as to be drivable only in the x-direction with respect to the y-direction drive stage 103.

The solid-state imaging device 101 is fixed onto the x-direction drive stage 102 through a thermal conduction plate 106 and an insulating film 107. The thermal conduction plate 106 is preferably formed of a material having high thermal conductivity such as aluminum or copper.

What is denoted by 105 is a thermal conduction member having one end connected to the thermal conduction plate 106 and the other end connected to the imaging apparatus case body 108 which has a greater thermal capacity than the thermal conduction plate 106. The thermal conduction member 105 is preferably formed of a material having high thermal conductivity such as aluminum or copper similarly to the thermal conduction plate 106. Further the thermal conduction member 105 has a thickness that provides flexibility, and preferably is formed for example into a mesh so as to be more flexible. Though not shown, an insulating film is formed on the surface of the portion of the thermal conduction member 105 excluding the portions connected to the thermal conduction plate 106 and the imaging apparatus case body 108.

With such a construction, a heat occurring at the solid-state imaging device 101 is transferred into the imaging apparatus case body 108 having a greater thermal capacity through the thermal conduction plate 106 and the thermal conduction member 105 which is flexible. The rise of temperature of the solid-state imaging device 101 is thereby efficiently restrained even when it is provided with the function for canceling the hand shake by moving the position of the solid-state imaging device 101. It is possible to secure a stability of electrical operation or to prevent deterioration in imaging characteristic of the solid-state imaging device 101.

While the thermal conduction member 105 is provided only on one end side of the thermal conduction plate 106, it may be provided in plurality on the other end side of the thermal conduction plate 106. Further, while one connecting the other end of the thermal conduction member 105 to the imaging apparatus case body 108 has been shown in this embodiment, it is naturally possible, instead of connecting the other end of the thermal conduction member 105 to the imaging apparatus case body 108, to connect it similarly to a cooling member having greater thermal capacity than the thermal conduction plate 106 so as to use it as a cooling means of the solid-state imaging device 101.

### Embodiment 2

A second embodiment of the invention will now be described. In the construction shown in the first embodiment, a contact connection to the thermal conduction plate 106 is made all over the entire back surface of the solid-state imaging device 101. To more efficiently effect the thermal radiation of the solid-state imaging device 101 in the present embodiment, a thermal conduction plate is provided at only those portions where a heat output by the solid-state imaging device 101 is large. A description will be given below only with respect to the manner of connection between the solid-state imaging device 101 and the thermal conduction plate 111. The construction of the rest is identical to the first embodiment and will not be described.

FIG. 4 is a view as seen from back side of the manner of connection between the solid-state imaging device 101 and the thermal conduction plate 111 in the second embodiment. The thermal conduction plate 111 of this embodiment in the illustrated example is provided as having L-like form only at a portion of the back side of the solid-state imaging device 101. It is preferable to provide the thermal conduction plate 111 correspondingly to the portion of amplification circuit, scanning circuit, etc. on the solid-state imaging device 101 where a heat output is considerable.

With such a construction, since the thermal conduction plate 111 is provided at a portion of the solid-state imaging device 101 where the heat output is considerable, a more efficient thermal radiation of the solid-state imaging device 101 becomes possible. If the heat conduction plate is provided all over the entire back surface of the solid-state imaging device, there is a fear that heat generated at the heat generating portion is transmitted to an effective pixel section of the solid-state imaging device through the thermal conduction plate. Such a problem is eliminated in the present embodiment. It should be noted that the means for moving the position of the solid-state imaging device includes but naturally not limited to the system described in the above embodiments.

According to the first aspect of the invention as has been described by way of the above embodiments, a heat generated at the solid-state imaging device is efficiently radiated so that it is possible to restrain the rise of temperature of the solid-state imaging device. A deterioration of image to be taken due to a temperature rise in the imaging apparatus having a mechanism for canceling a hand shake can be prevented. According to the second aspect, it becomes possible to reduce the load at the time of moving the position of the solid-state imaging device so as to cancel the hand shake. According to the third aspect, it is possible to improve a flexibility of the second thermal conduction member so that the load at the time of moving the position of the solid-state imaging device can be further reduced. According to the fourth aspect, it is possible to more efficiently accelerate the thermal radiation of the solid-state imaging device.

What is claimed is:

1. An imaging apparatus for converting an object image formed by a taking optical system into an image signal, said imaging apparatus comprising:
a solid-state imaging device for converting said object image into said image signal, attached to a case body of said imaging apparatus such that its light receiving plane is movable on a plane crossing an optical axis of said taking optical system;
a first thermal conduction member attached to said solid-state imaging device; and
a second thermal conduction member connected at one end to said first thermal conduction member and at the other end to a thermal radiation member having a thermal capacity greater than said first thermal conduction member.

2. The imaging apparatus according to claim 1, wherein said second thermal conduction member comprises a member having flexibility.

3. The imaging apparatus according to claim 1, wherein said second thermal conduction member comprises a mesh-like metal.

4. The imaging apparatus according to claim 1, wherein said first thermal conduction member is attached to only a portion of said solid-state imaging device where a heat output is large.
